(19) United States
(12) Patent Application Publication
(10) Pub. No.: US 2009/0071060 A1
(43) Pub. Date: Mar. 19, 2009

(54) Trap for Flying Insects

(76) Inventor: Marilyn McKay, Barrie (CA)

Correspondence Address: PLAGER LAW OFFICES, 16152 BEACG BLVD., SUITE 207, HUNTINGTON BEACH, CA, 92647, US

(21) Appl. No.: 11/856,671

(22) Filed: Sep. 17, 2007

(51) Int. Cl. A01M 1/10; A01M 1/02

(52) U.S. Cl. 43/122; 43/107

(57) ABSTRACT

A flying insect trap comprising a hollow housing with a canal descending through the top face of the housing into said hollow housing, and a plurality of barbs located internally throughout said canal to impale said insects upon ascending through said canal in an effort to escape said trap. The barbs are preferably angled downward to facilitate entry into said trap and impalement of said insects ascent when attempting escape from said trap. Either or both ends of the housing are removeable to permit cleansing and reloading of the bait inside the trap.

### FIELD OF THE INVENTION

The present invention relates generally to wash brushes, and more particularly, to wash brushes which are multi-functional with the inclusion of a rotating brush or sponge driven by an impellor in direct response to pressurize water communicating with the impellor, a multi-function shower head, and direct outlet. The brush housing includes a reservoir for cleansing products which may be introduced directly into the water flow creating a water-cleanser mix upon discharge of the water through the brush.

### BACKGROUND OF THE INVENTION

Water-operated wash brushes are known for use in many cleaning applications, such as cleaning persons, dishes, floors, walls, and vehicles. Such wash brushes commonly include an upper casing into which a nozzle forcefully directs a tangential jet of water that rotatably drives a turbine-like impellor, which in turn through appropriate reducing gears, drives a wash brush supported in depending relation to the casing at a rotary speed less than the turbine. The wash brush is constantly wetted by the water that produces the brush rotation.

The application of cleansing liquids to the brushes generally requires the direct application of the cleaner to the brush. To simplify the washing process, the cleanser is introduced into the water stream which in turn comes into contact with the brush. Rather than removing the brush from the spigot or hose, a direct water outlet is included in the brush to allow rinsing of the cleaned object.

### OBJECTS AND SUMMARY OF THE INVENTION

It is an object of the present invention to provide a water-operated wash brush that is adapted for

Other objects and advantages of the invention will become apparent upon reading the following detailed description and upon reference to the drawings, in which:

### BRIEF DESCRIPTION OF THE DRAWINGS

FIG. 1 is a

FIG. 2 is a;

FIG. 3 is a; and

FIG. 4 is a

While the invention is susceptible of various modifications and alternative constructions, certain illustrated embodiments thereof have been shown in the drawings and will be described below in detail. It should be understood, however, that there is no intention to limit the invention to the specific forms disclosed, but on the contrary, the intention is to cover all modifications, alternative constructions and equivalents falling within the spirit and scope of the invention.

### DESCRIPTION OF THE PREFERRED EMBODIMENTS

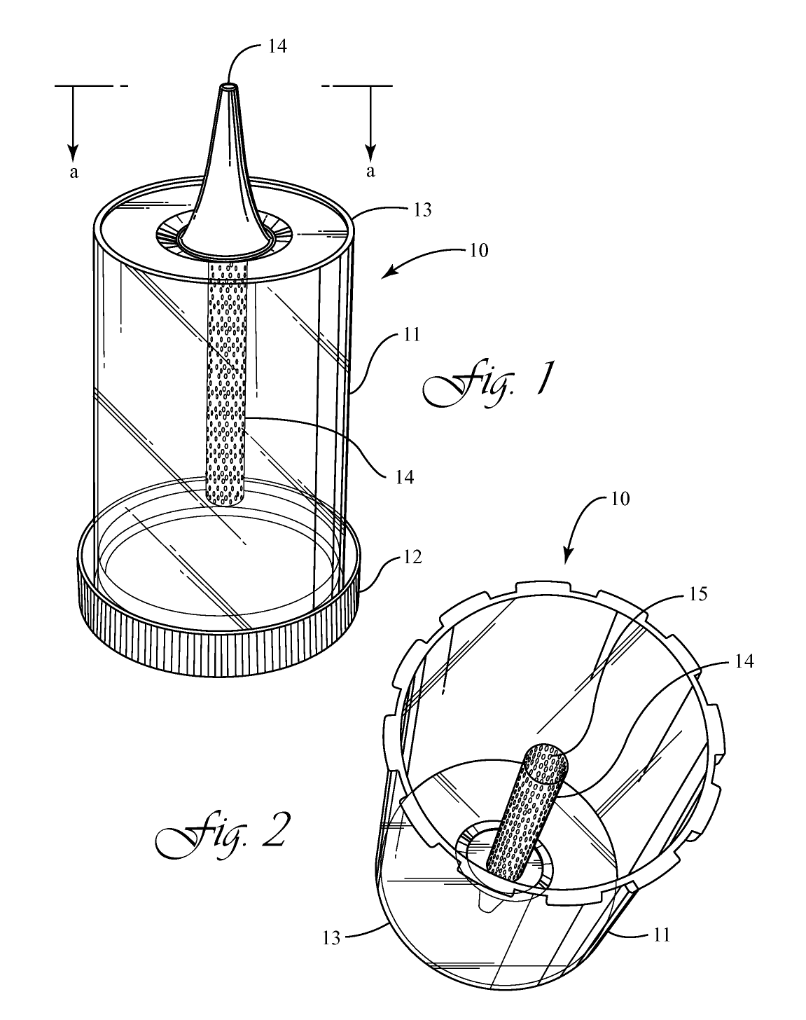

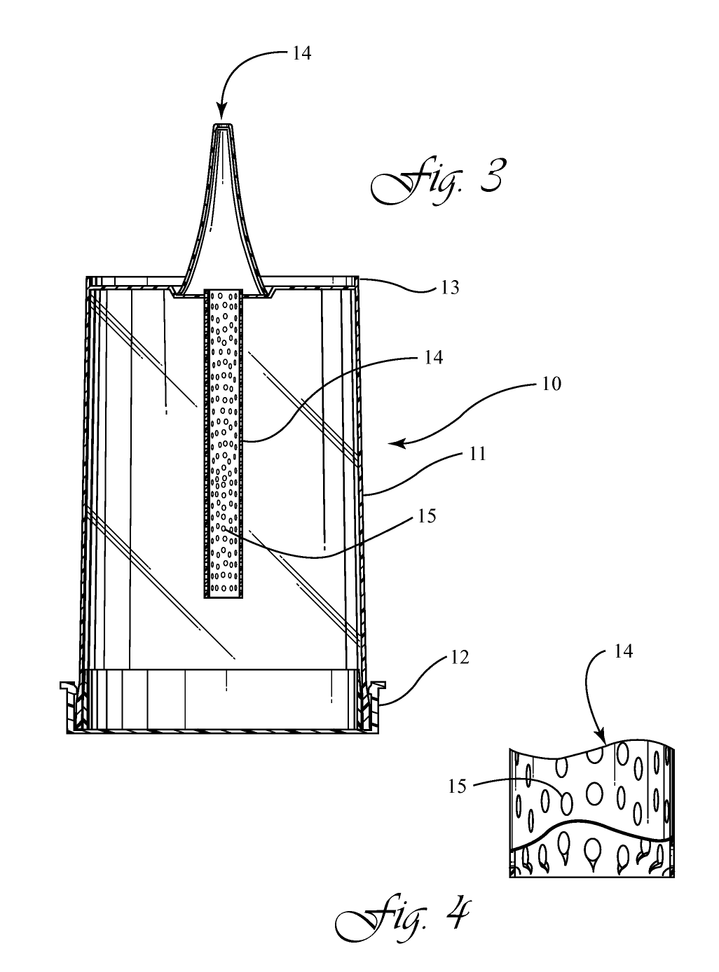

Referring now more particularly to FIG. 1 of the drawings, there is shown an illustrative wash brush 10 in accordance with the invention. The wash brush 10 includes a casing 11 and a rotary brush 14 supported co-axially for relative rotation as an incident to the supply of washing liquid to the wash brush. The casing 11 in this case includes a downwardly opening cup-shaped cover 15 and a lower frame plate 16. A hollow support and liquid supply rod 18 is connected in outwardly extending fashion to the cover 15 for coupling to a supply of water or other cleaning fluid in a known manner. A nozzle insert 19 is secured in the downstream end of the rod 18 for forcefully directing a tangential liquid flow stream into an internal chamber 20 defined by the cover 15. The frame plate 16 in this instance includes a plurality of radial spokes 21 which extend between an outer ring 22 from which the fixed brush is supported and a central hub 24. The fixed brush 12 has bristles which extend in slight outwardly extending frustoconical relation to the outer ring 22.

The rotary brush 14 is fixed to a central shaft 30 which is rotatably supported between a central opening in the frame hub 24 and a socket 31 integrally formed in depending relation to the cover 15. Respective bushings 32, 34 are provided between the shaft 30 and the frame hub 24 and socket 31 for facilitating relative rotational movement of the shaft 30. The rotary brush 14 includes an upper base 35 with a central hub 36 that is fixed to the shaft 30 by a bolt 38 and which carries an annular array of downwardly directed bristles 39. The bristles 39 of the rotary brush 14 in this instance extend in substantially parallel relation to the axis of rotation. The base 35 of the illustrated rotary brush 14 is formed with a plurality of circumferentially spaced openings 37.

For rotating the rotary brush 14 as an incident to direction of pressurized water or other cleaning fluid into the casing 11 through the tangential nozzle 19, an impellor 40 is supported on the shaft 30 for relative rotation. The impellor 40 includes a central hub 41 mounted about the shaft 30 and an outer cylindrical sidewall 42 formed with a plurality of equally spaced cordal blades 44 which are driven by discharging liquid from the tangential nozzle 19. A bushing 45 is provided between the impellor hub 41 and the shaft 30 to facilitate relative rotation. Rotary movement of the impellor 40 is transmitted to the rotary brush 14 through a reducing gear train 50.

In accordance with one aspect of the invention, the cover of the brush is made of a transparent material which enables a user to observe operation of the impellor and the speed reducing gear train is disposed below the impellor for more ascetic appearance. To this end, the cover 15 preferably is made of a clear plastic material, which may be economically produced by injection molding, and the impellor 40 has a downwardly opening cup shape which overlies the speed reducing gear train 50. The impellor 40 in this case has an upper horizontal wall 51 disposed adjacent an upper perimeter of the discharge orifice of the nozzle 19 such that the cylindrical sidewall 42 and blades 44 are engaged by the discharging flow stream from the nozzle 19.

For transmitting rotary motion to the rotary brush 14, the reducing gear train 50 in this instance includes gear teeth 52 formed on the impellor hub 41 which cooperate with the teeth of a larger diameter gear wheel 53 supported for rotation about an upwardly turned pin 54 mounted in fixed relation to the frame plate 16. The gear wheel 53 includes a smaller diameter hub formed with gear teeth 55 for in turn driving a larger diameter gear wheel 56 fixed to the shaft 30. Hence, rotational movement of the impellor 40 will drive the central shaft 30 and rotary brush 14 through the gear train 50 at a rotatable speed less than the impellor 14, preferably a rotational speed equal to one-quarter of the rotational speed of the impellor. With the gear train 50 disposed below the impellor, they are hidden when viewed from the top of the brush through the clear plastic cover 15 if the impellor 40 is made of a non-transparent material. Even if the impellor 40 is made of a transparent or translucent material, the gear train is not directly under the cover. In either case, operation of the impellor 40 can be viewed through the cover 15 more ascetically. Since the downwardly opening cup-shaped impellor 40 substantially overlies the reducing gear train 50 of the rotary brush 14, the cylindrical sidewall 42 of the impellor 40 also prevents the liquid flow stream which drives the impellor 40 from directly impinging upon the reducing gears, and furthermore, causes the water to be flung radially outwardly within the cover for direction downwardly through the bristles 39 of the rotary brush 14 without impeding operation of the reducing gear train 50.

In carrying out a further feature of the invention, a splash plate is provided on the underside of the speed reducing gear train for preventing splash back of liquid from the rotary brush that might impede operation of the gear train, and hence, rotary movement of the brush. To this end, a generally circular splash plate 60 is mounted in fixed relation on the casing frame plate 16 about the shaft 30 between the gear train 50 and rotary brush 14. The splash plate 60 preferably has a diameter of at least one-half of the diameter of the impellor, and most preferably, at least three-quarters of the diameter of the impellor, for substantially preventing backsplash of liquid from the rotary brush 14 against the reducing gears and teeth. The upstanding support pin 54 for the gear 53 in this case is supported on the splash plate 60, which in turn is fixed to the casing frame plate 16. Alternatively, as shown in FIG. 4, the splash plate 60 may be an integrally formed part of the frame plate 16.

From the foregoing, it can be seen that the water operated wash brush of the present invention is adapted for efficient and economical manufacture and has an ascetically pleasing appearance even when assembled with a clear plastic casing. While the wash brush has a reducing gear train disposed below the impellor for aesthetic purposes, it is effectively protected from liquid that can impede reliable rotary action of the brush.

What is claimed is:

1. A flying insect trap comprising:
a hollow housing with a cap, and a base;
a canal descending from said top into said housing;
a plurality of barbs located internally throughout said canal to impale said insects upon ascending through said canal in an effort to escape said trap.

2. The flying insect trap of claim 1 wherein said housing is preferably cylindrical.

3. The flying insect trap of claim 1 wherein said canal protrudes outward from said cap as well as downward into said housing.

4. The flying insect trap of claim 1 wherein said housing is detachable from said base face.

5. The flying insect trap of claim 1 wherein said cap is detachable from said housing.

6. The flying insect trap of claim 1 wherein said barbs are angled downward to insure impalement of said insects only upon attempted ascent through said canal in an effort to escape said trap.

7. The flying insect trap of claim 1 wherein said canal comprises a diameter of between 0.5 cm to 1.5 cm.

8. The flying insect trap of claim 1 wherein said bottom is adapted to retain bait within said housing to attract said insects into said trap.

9. A flying insect trap comprising:
a generally cylindrical housing;
a base removeably fitted to said housing;
a cap fitted to said housing opposite said base;
a canal descending from said cap into said housing;
a plurality of barbs located throughout said canal to impale said insects upon ascending through said canal in an effort to escape said trap.

10. The flying insect trap of claim 9 wherein said canal protrudes outward from said cap as well as downward into said housing.

11. The flying insect trap of claim 9 wherein said cap is detachable from said housing.

12. The flying insect trap of claim 9 wherein said barbs are angled downward to insure impalement of said insects only upon attempted ascent through said canal in an effort to escape said trap.

13. The flying insect trap of claim 9 wherein said canal comprises a diameter of between 0.5 cm to 1.5 cm.

14. The flying insect trap of claim 9 wherein said bottom face is adapted to retain bait to attract said insects into said trap.
